(19) United States
(12) Patent Application Publication
(10) Pub. No.: US 2021/0200797 A1
(43) Pub. Date: Jul. 1, 2021

(54) RELEVANCE ANALYZING DEVICE AND METHOD

(71) Applicant: Hitachi, Ltd., Tokyo (JP)

(72) Inventors: Hiroko OTAKI, Tokyo (JP); Kunihiko KIDO, Tokyo (JP)

(21) Appl. No.: 17/129,993

(22) Filed: Dec. 22, 2020

(30) Foreign Application Priority Data
Dec. 25, 2019 (JP) 2019-234041

(51) Int. Cl. G06F 16/332; G06F 16/33; G06F 16/901

(52) U.S. Cl. CPC G06F 16/3326; G06F 16/9024; G06F 16/3331

(57) ABSTRACT

It becomes possible to implement a route search fast, and furthermore routes whose meanings are easy to understand are searched for by linking routes on the basis of relations with similar backgrounds. A provided relevance analyzing device includes a control section and a database. The database stores: node data about nodes on a network representing relevance between a plurality of events, and edge data about edges representing interrelationships between the events. The control section includes: an inter-edge background similarity computing section that computes a similarity between documents corresponding to two edges by using the node data and edge data stored in the database; and a route computing section that computes routes with high similarities as routes on the network.

### CLAIM OF PRIORITY

The present application claims priority from Japanese patent application JP 2019-234041 filed on Dec. 25, 2019, the content of which is hereby incorporated by reference into this application.

### BACKGROUND OF THE INVENTION

The present invention relates to a relevance analyzing device and method for analyzing a network created by extracting relations between events, and associating relations between a plurality of events with each other.

In recent years, there are ongoing advances in systematic studies about: genes and proteins which are gene products; the functions of genes and proteins; estimation of genes to be causes or backgrounds (hereinafter, called backgrounds) of disorders; and connections with gene polymorphisms. Results of these studies are made open as documents in medical biology papers, and there is a growing expectation for medical cares and new drug development based on the study results.

In new drug development, it is desired not only to understand separate knowledge about in vivo actions, biomolecules like genes and proteins, and events such as biological/pathological events which are in vivo reactions, but also to completely understand all routes of diseases, that is, a series of biochemical routes inside a body that have triggered a disease.

In individual studies, actions of biomolecules like the ones described below are revealed, and described in a medical biology paper.
The adjustment of gene A causes the expression of protein A
Protein A phosphorates protein B and a certain cell type.
Protein B adjusts gene C by the phosphorylation.
The adjustment of gene C causes the expression of protein C.
Protein C activates T cell.
The activation of T cell triggers inflammation.

Words like gene A, gene C, protein A, protein B, protein C, T cell, and inflammation correspond to biomolecules in these examples. In addition, a word like inflammation corresponds to a biological/pathological event. Words like “express,” “phosphorate,” “adjust,” “activate,” and “trigger” correspond to actions of the biomolecules.

By associating the biomolecules and biological/pathological events by actions, in the present example, it is possible to obtained a connection, gene A→protein A→protein B→gene C→protein C→T cell→inflammation, and to gain knowledge that protein A is related to inflammation. From this knowledge, it is thought that a drug to inhibit the function of protein A has an effect on the inflammation related to protein A.

In this manner, information about an action between biomolecules included in a document such as a medical biology paper is stored as information of a pair of two molecules, and the information is associated with each other to generate a network. Then, there is a method in which routes that connect two molecules are searched for, and routes between the two molecules are presented to assist understanding of disorders and pathology on the molecular level (see WO02/023395).

### SUMMARY OF THE INVENTION

According to the method of WO02/023395, in a case where a relation between a biomolecule (molecule A) and a biomolecule (molecule B) is to be investigated, it is necessary to perform a route search by using an enormous number of molecule pairs as targets, and in a case where a route between the molecule A and the molecule B is long, it becomes virtually impossible to perform the search. In view of this, data is stratified, a connection search for relevance between a sub-network and a sub-network is performed on an upper layer, and in a case where a route is found on the upper layer, a connection search is performed on a lower layer of each sub-network on the route, as necessary. By dividing a route search problem into problems in different layers in this manner, it is made possible to perform a search for relevance between two biomolecules of interest that has otherwise been impossible in a case where stratification is not used. For example, sub-networks that have been narrowed down in terms of biomolecule generated by the liver, biological events occurring on skin, and the like are created by using information of generating organs, affected organs, and the like, and a connection search is performed, thereby making it possible to search for relevance between two biomolecules of interest.

According to WO02/023395 mentioned above, it is necessary to stratify in advance biomolecules or biological events. In WO02/023395, it is defined, about relevance between biomolecules, in which affected organs the relevance is observed, and in which biological events/pathological events the relevance is involved. Although, by taking out only relevance between biomolecules that can occur in a particular affected organ or a biological event/pathological event, it becomes possible to search a molecule function network in the target layer, it is not realistic to define, in advance, stratification of all biomolecules, and relevance between molecules in the circumstance where an enormous amount of documents as medical biology literatures is published every year.

When a connection search for biomolecules and biological/pathological events is performed in a route search problem, preceding and following biomolecules and biological/pathological events are preferably connected on the basis of backgrounds that have identical or similar relevance. It is thought that diverse information should be defined as backgrounds, and such information should cover not only affected organs, but also target disorders/experiment conditions, and the like. In a case where a route search is actually performed without using constraints based on background information, a connection search couples biomolecules and biological/pathological events, but there is a problem that the coupled information is meaningless because biomolecules and biological/pathological events with different backgrounds are coupled.

An object of the present invention is to provide a relevance analyzing device and method that use events with backgrounds that have identical or similar relevance in order to overcome the problems mentioned above.

In order to overcome the problem described above, the present invention provides a relevance analyzing device that computes a similarity between documents corresponding to an edge that is in a network representing relevance between a plurality of events and represents an interrelationship between two events, and presents an edge with a high similarity as a route on the network.

In addition, in order to achieve the object described above, the present invention provides a relevance analyzing device including a control section, a database, and an input/output section. The database stores: node data about nodes on a network representing relevance between a plurality of events; and edge data about edges representing interrelationships between the plurality of events, and the control section includes an inter-edge background similarity computing section that computes a similarity between documents corresponding to two edges by using the node data and edge data.

Furthermore, in order to achieve the object described above, the present invention provides a relevance analysis method of analyzing relevance between a plurality of events by a control section. The control section computes a similarity between documents corresponding to an edge that is in a network representing relevance between a plurality of events and represents an interrelationship between two events, and presents, as a route on the network, an edge with a high similarity.

According to the present invention, it becomes possible to implement a route search fast, and furthermore it is possible to search for routes whose meanings are easy to understand by linking routes on the basis of relations with similar backgrounds.

### BRIEF DESCRIPTION OF THE DRAWINGS

FIG. 1 is a hardware configuration diagram of a relevance analyzing device in a first embodiment;

FIG. 2 is a functional block diagram of the relevance analyzing device in the first embodiment;

FIG. 3 is a figure illustrating one example of the flow of a process of computing inter-edge background similarities in the first embodiment;

FIG. 4 is a figure illustrating one example of the flow of a route computation process in the first embodiment;

FIG. 5 is a figure illustrating one example of a data structure of node data in the first embodiment;

FIG. 6 is a figure illustrating one example of a data structure of edge data in the first embodiment;

FIG. 7 is a figure illustrating one example of a data structure about the storage of similarities of the edge data in the first embodiment;

FIG. 8 is a figure illustrating one example of a data structure about the storage of route search results in the first embodiment;

FIG. 9 is a figure illustrating one example of a network configured according to the first embodiment;

FIG. 10 is a figure for explaining parsing that is used when the node data and the edge data are collected from literatures in the first embodiment;

FIG. 11 is a figure illustrating one example of an input screen used at the time of a route search in the first embodiment;

FIG. 12 is a figure illustrating one example of an output screen used at the time of a route search in the first embodiment; and

FIG. 13 is a figure illustrating one example of the flow of the route computation process in a third embodiment.

### DETAILED DESCRIPTION OF THE PREFERRED EMBODIMENTS

In the following, embodiments for carrying out the present invention are explained sequentially in accordance with the drawings, and before that, the present invention is generally explained. In the present specification, events mean biomolecules, biological/pathological events which are in vivo reactions, and the like, nodes mean vertexes on a network indicating relations between the events, and edges mean edges on the network that represent interrelationships such as interactions or control relations between events between nodes.

In the present invention, about events such as biomolecules, biological/pathological events, and the like described in documents such as medical biology papers, and interrelationships between the events, the events such as biomolecules and biological/pathological events are represented as nodes on a network, the interrelationships between the events such as biological/pathological events are represented as edges between nodes, and relevance between nodes that appear in a plurality of documents is represented as the network.

Then, in a case where two nodes in the network are designated by a user, and it is desired to reveal whether there is some biological relevance between the two nodes, a search for routes between the two nodes is performed. In the route search according to the present invention, in a case where backgrounds of actions that occur between biomolecules, biological/pathological events, and the like are similar, the biomolecules, and the biological/pathological events are connected with each other, and thereby a route with similar backgrounds is presented as a search result. In doing so, a similarity of backgrounds is determined about an input edge to a particular node and an output edge from the node on the basis of descriptions of original documents from which information of the nodes has been obtained. In a case where the background similarity can be determined as being high, the events can be connected.

Thereby, regarding a problem that in a case where a relation between a biomolecule (molecule A) and a biomolecule (molecule B) is to be investigated, a route search needs to be performed by using an enormous number of molecule pairs as targets, and it becomes virtually impossible to perform a search in a case where a route between the molecule A and the molecule B is long, it becomes possible to implement a route search or becomes possible to perform the route search fast by drawing a network including only edges with high inter-edge background similarities, and pruning the network, and furthermore it becomes possible to search for routes on the basis of relations with similar backgrounds, enabling a search for routes whose meanings are easier to understand. Even in a case where a plurality of routes can be presented, the routes can be presented in an order in such a manner that meanings of the routes can be easily understood, and a user can arrive fast at information that he/she wants to see.

### First Embodiment

In a relevance analyzing device and method in a first embodiment, a similarity between documents (hereinafter, called documents) corresponding to an edge that is in a network representing relevance between a plurality of events, and represents an interrelationship between two events is computed, and edges with a high similarity is presented as a route on the network.

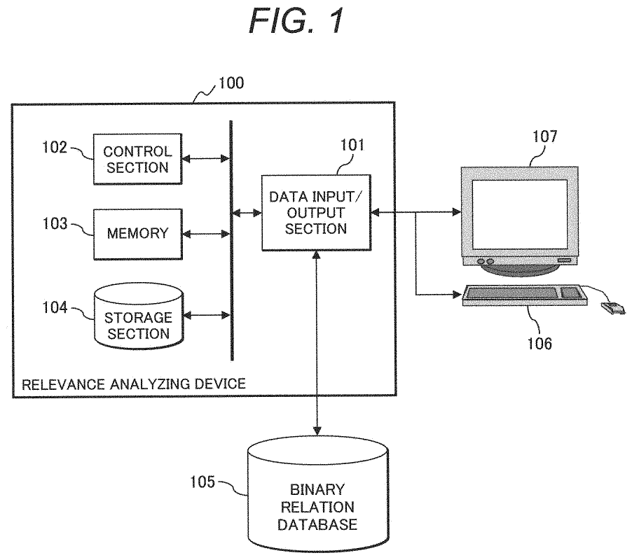

A hardware configuration that realizes the relevance analyzing device in the first embodiment is explained by using FIG. 1. A relevance analyzing device 100 is a so-called computer, and specifically includes a data input/output section 101, a control section 102, a memory 103, and a storage section 104. The relevance analyzing device 100 is connected to external devices such as a binary relation database 105, and an input section 106 and display section 107 which are input/output sections. In the present specification, the whole including the relevance analyzing device 100, and the database and the input/output sections is collectively called a relevance analyzing device in some cases. Hereinafter, the configuration/function of each section is explained.

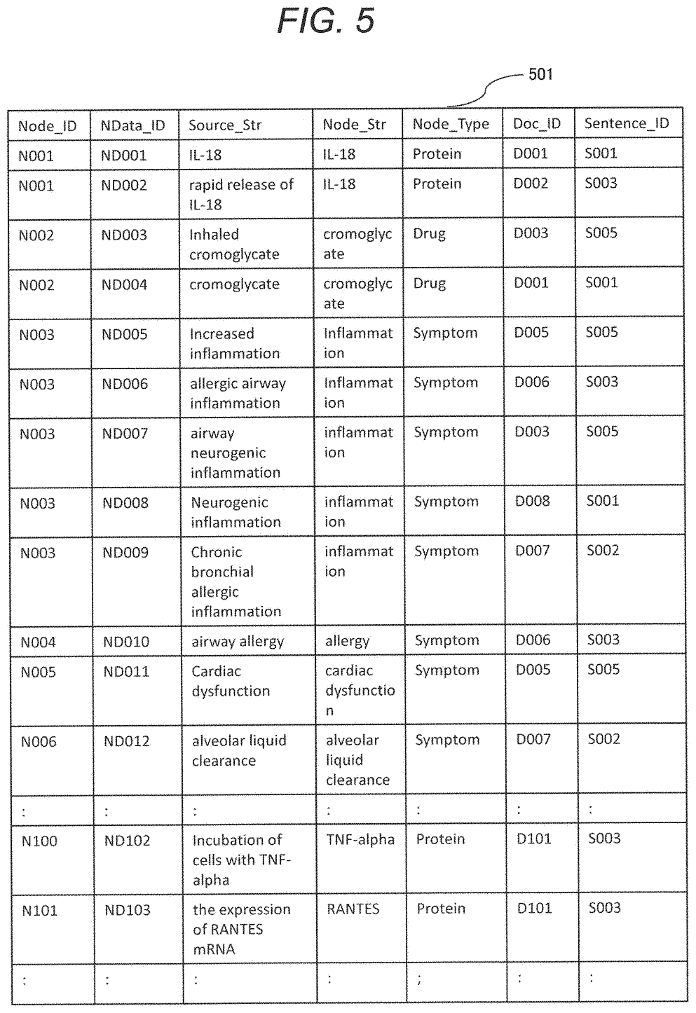

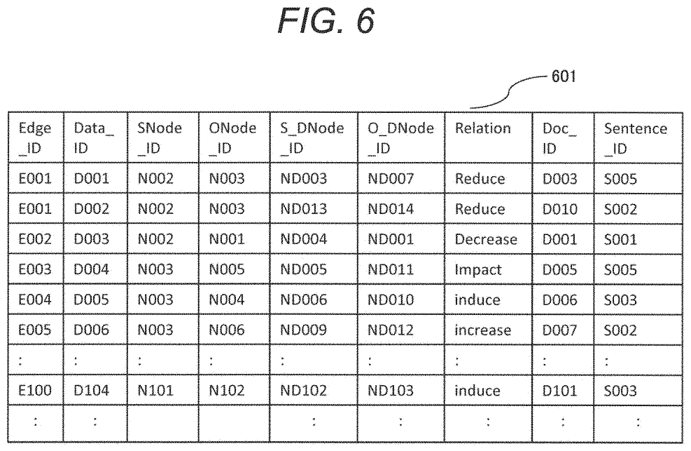

The data input/output section 101 is an interface that transmits and receives various types of data to and from the binary relation database 105, the input section 106, and the display section 107. The display section 107 is a device on which execution results and the like of programs are displayed, and specifically is a liquid crystal display or the like. The input section 106 is a manipulation device to be used by an operator to give manipulation instructions to the relevance analyzing device 100, and specifically is a keyboard, a mouse, and the like. The mouse may be another pointing device such as a track pad or a track ball. In addition, in a case where the display section 107 is a touch panel, the touch panel functions also as the input section 106. The binary relation database 105 stores data of various nodes and edges. An example of the structure of the data of nodes is mentioned below by using FIG. 5, and an example of the structure of the data of edges is mentioned below by using FIG. 6.

The control section 102 is a device that controls the operation of each constituent element, and specifically is a CPU (Central Processing Unit) or the like. The control section 102 loads, into the memory 103, various types of functional programs, and data necessary for the programs that are stored on the storage section 104, and executes the programs. The memory 103 stores the programs to be executed by the control section 102, intermediate data of ongoing calculation processes, and the like. The storage section 104 is a device that stores programs to be executed by the control section 102, and data necessary for the execution of the programs. The storage section 104 is specifically a device that writes and reads data in and from a recording device such as an HDD (Hard Disk Drive) or an SSD (Solid State Drive), and a recording medium such as an IC card, an SD card, or a DVD.

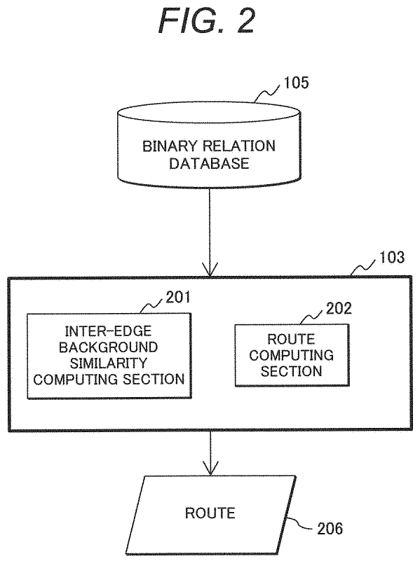

Functions of the relevance analyzing device 100 in the present embodiment are explained by using FIG. 2. Note that these functions may be configured with dedicated hardware by using an ASIC (Application Specific Integrated Circuit), a FPGA (Field-Programmable Gate Array) or the like, or may be configured with software programs that are stored on the memory 103 and operate on the control section 102. In the case explained in the following explanation, each function is configured with a program. In the present embodiment, an inter-edge background similarity computing section 201 and a route computing section 202 are included as programs to realize the functions. Hereinafter, each section is explained.

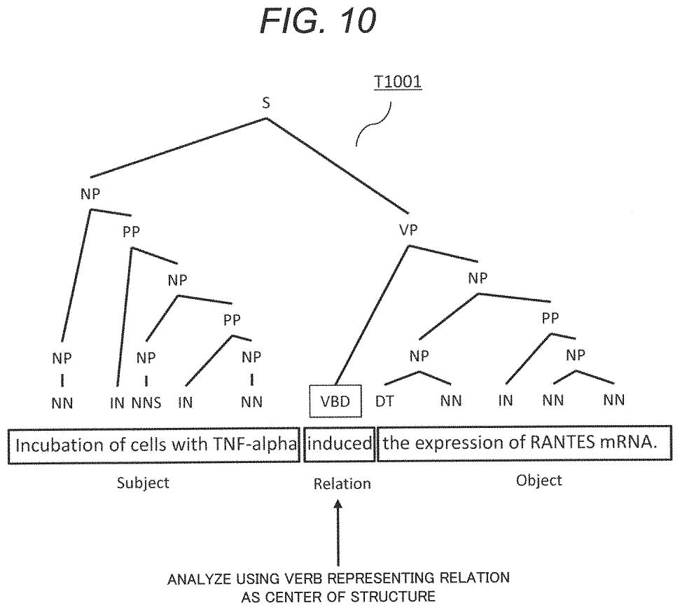

Note that the relevance analyzing device creates edge data and node data in advance, and accumulates them in the binary relation database 105. The edge data is created from documents that describe relations such as changes and actions between biomolecules by executing a functional program as appropriate. A document is first split into sentences, and a phrase structure analysis like the one illustrated as one example in FIG. 10 is performed on the sentences obtained by the splitting. Here, the phrase structure is an expression format in which a plurality of words are combined to form a phrase, and furthermore a plurality of phrases are combined to form a larger phrase.

FIG. 10 illustrates T1001 as one example of the phrase structure. In the phrase structure T1001, words are leaves, that is, nodes without children, and between those words and the root, there are intermediate nodes indicating parts of speech and types of phrases. Methods of analysis for representing sentences as phrase structures are called phrase structure analysis. In the example illustrated in FIG. 10, a noun (NN) “TNF-alpha” is combined with a preposition (IN) “with” to form a prepositional phrase (PP), the prepositional phrase and “cells” are combined to form a noun phrase, furthermore the noun phrase and a prepositional phrase “of” are combined to form a prepositional phrase, and still furthermore the prepositional phrase and a noun “Incubation” are combined to form a noun phrase. Similarly, “the expression of RANTES mRNA” is collectively one noun phrase. Furthermore, the noun phrase and a verb (VBD) “induced” are combined to form a verb phrase. With such a phrase structure analysis, a verb included in a verb phrase, a noun phrase of a subject section, and a noun phrase of an object section are identified. Furthermore, verbs indicating relations between biomolecules are defined in advance, and in a case where a verb indicating a relation between biomolecules is included in a verb phrase in a sentence, attention is first paid to the sentence as a candidate sentence.

Thereafter, the control section 102 performs matching between the noun phrase of the subject section and the noun phrase of the object word, and dictionaries of disorders, drugs/proteins, and the like. In the example illustrated in FIG. 10, the noun phrase of the subject section is “Incubation of cells with TNF-alpha,” the noun phrase of the object section is “the expression of RANTES mRNA,” and the verb is “induce.” Matching between the noun phrases and dictionaries is performed. In the example, for example, “TNF-alpha” and “RANTES” match items in a dictionary of proteins. In a case where there is a matching item, edge data is created in which a character string taken out from a subject section is set as an event of the start point of an edge, and a character string taken out from an object section is set as an event of the end point of the edge. A verb phrase is used as a relation of the edge data. Such edge data is created in advance from the whole of a set of biomedical literatures, and is stored as edge data in the binary relation database 105 along with an ID of an original document from which the edge data has been created.

At that time, node data is created first. FIG. 5 illustrates node data 501 as one example thereof. A node data ID (Ndata_ID) is generated for each of events taken out from the literatures. Then, a noun phrase of the node data itself is stored as a source string (Source_Str), and a word that matches an item in a dictionary is stored as a node string (Node_Str). Because the meaning of the node string can be given in accordance with the type of the dictionary, the type of the dictionary including the matching item is stored as a node type (Node_Type). In the example, because “TNF-alpha” and “RANTES” matched items in the dictionary of proteins, the node type is protein (Protein). In addition, an ID (Doc_ID) of a document, and the number (Sentence_ID) of a sentence are stored such that the original literature from which each piece of data has been taken out can be identified. A character string number of a character string that has been taken out within a document may be stored at the same time such that the position of the character string can be known. Then, a node ID (Node_ID) that is allocated to identical events, and identifies a group of the identical events is stored also. If the concepts of node strings of events match, the events are grouped into the same group, and given the same node ID, for example. At that time, synonyms are decided, and it is determined whether or not the concepts of the node strings match.

Next, the storage of edge data is explained. FIG. 6 illustrates one example. Edge data 601 is data in which a character string taken out from a subject section is set as an event of the start point of an edge, and a character string taken out from an object section is set as an event of the end point of the edge. Here, information indicating from which literature a character string has been taken out, and to which data a source string corresponds is kept and stored. Accordingly, node data IDs are used to represent the start point and end point of an edge.

In the edge data 601 illustrated in FIG. 6, the start point of an edge correspond to a subject section node ID (Snode_ID), and a subject section data node ID (S_Dnode_ID), and the end point of the edge corresponds to an object section node ID (Onode_ID), and an object section data node ID (O_Dnode_ID). Data representing a relation between nodes is stored as a relation (Relation). Here, a verb that is found in the analysis of edge data corresponds to the relation.

In addition, an ID (Doc_ID) of a document and the number (Sentence_ID) of a sentence are stored such that the original literature from which data has been taken out can be identified. Then, an identifier of an individual piece of data of an edge is stored as a data ID (Data_ID). In a case where events of two nodes included in an edge, and a relation thereof are the same, that is, in a case where subject section node IDs, object section node IDs and relations are the same, the same edge ID (Edge_ID) is given as an ID indicating that the pieces of data belong to the same group. Note that, in the present specification, subject section node IDs, subject section data node IDs, object section node IDs, and object section data node IDs are called affecting node IDs, affecting entity node IDs, affected node IDs, and affected entity node ID, respectively, in some cases.

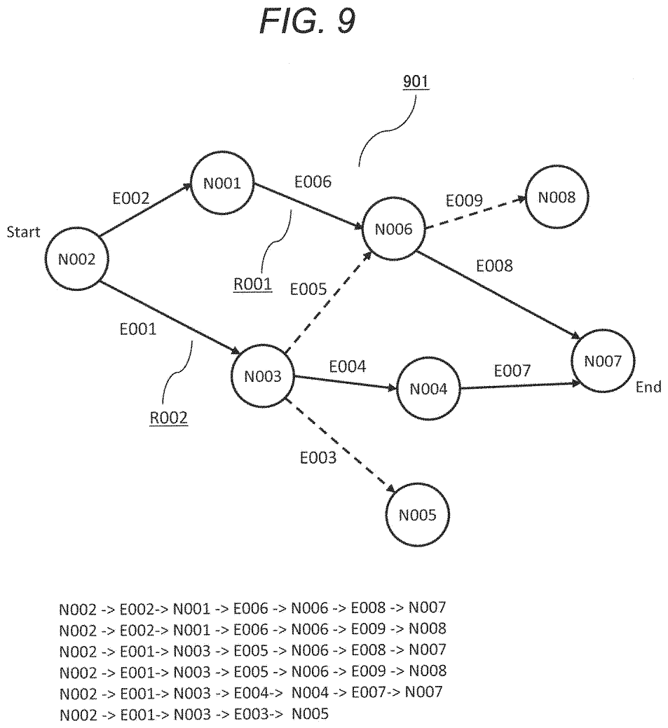

In the relevance analyzing device in the present embodiment, a plurality of documents are analyzed, and node data/edge data is collected comprehensively in advance in this manner. Then, the plurality of edges are coupled, and a network 901 like the one illustrated in FIG. 9 is created. In the figure, edges with low similarities are displayed with broken lines, and edges that are determined to have high similarities that are equal to or higher than a threshold are indicated by solid lines. Normally, a network also including portions with low similarities that are displayed with broken lines like the one illustrated in FIG. 9 is created.

Subsequently, a route search performed by the relevance analyzing device in the present embodiment by using the created network is explained. First, a method of realizing a high-speed route search by drawing a network with solid lines indicating pairs of two adjacent edges with high background similarities, and pruning the network is explained.

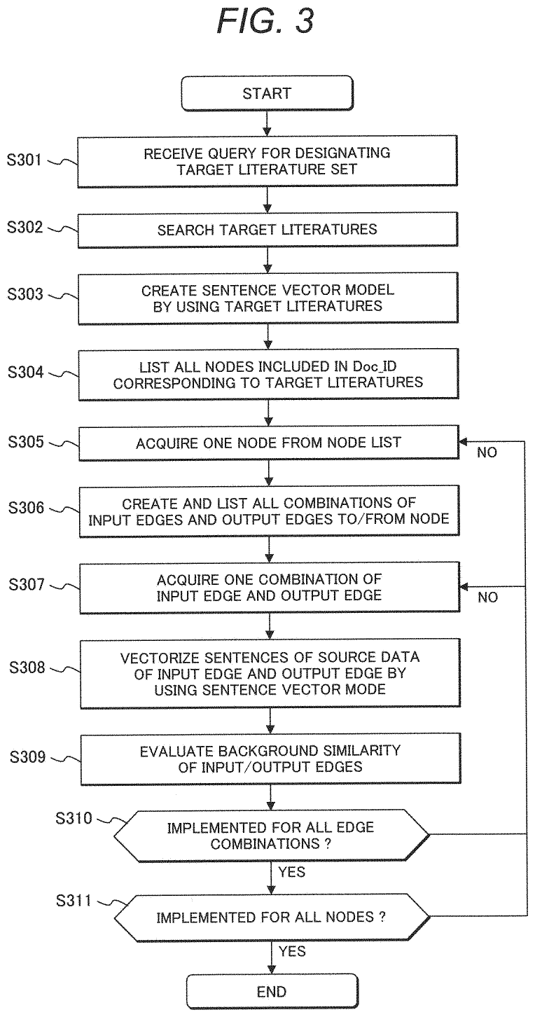

An inter-edge similarity computation process by the inter-edge background similarity computing section 201 illustrated in FIG. 2 is explained by using a processing flow illustrated in FIG. 3. The inter-edge background similarity computation is performed on a target literature set used for generation of a network. Accordingly, a query for designating the target literature set used for generation of the network is received from a user (S301). Target literatures are searched for in the literature set, and collected (S302). Possible examples of the literature set include, for example, MEDLINE, life science journals, and the like.

Subsequently, a group of literatures related to the query input by the user is learned, and a sentence vector model is created (S303). The group of literatures used as a learning target may be a literature set not particularly related to the query. As the sentence vector model, a technique of vectorizing sentences such as Doc2Vec or Sent2Vec can be used, and a technique of vectorizing words called Word2Vec can also be used to create a vectorized model of words, and vectorize target sentences to be vectorized.

Next, data of nodes included in the group of literatures related to the query input by the user are extracted, and put in a list (S304). The node list can be created by filtering node data by using document IDs of the group of literatures. One node is acquired from the node list (S305). All the combinations of input edges and output edges to and from the node are created, and put in a list (S306).

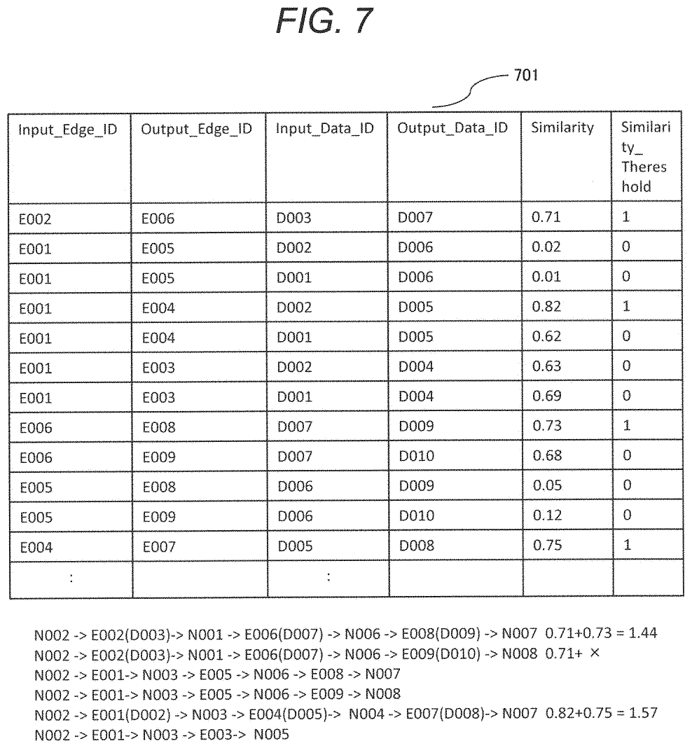

FIG. 7 illustrates one example of a data structure about the storage of similarities of the edge data. A list 701 illustrated in FIG. 7 represents an example of combinations of input edges and output edges. The list includes: input edge IDs (Input_Edge_ID), output edge IDs (Out_Edge_ID), input edge data IDs (Input_Data_ID), output edge data IDs (Out_Data_ID), similarities (Similarity), and similarity threshold decision results (Similarity_Threshold). Combinations are created on the basis of not edge IDs, but edge data IDs. Edge data IDs are IDs that are associated with original literatures from which data of the edges has been extracted, and pieces of data that represent similar edges are given an edge ID as an ID indicating that the pieces of data belong to the same group.

Next, one combination of input edge data and output edge data is acquired (S307), and sentences of original source data form which the input edge data has been generated are vectorized by using the sentence vector model (S308).

In the first line in the list 701 illustrated in FIG. 7, the input edge data is D003. In the edge data 601 illustrated in FIG. 6, data with the data ID=D003 is in the third line. At this time, the abstract of a document ID=D001 is used, for example, as sentences of original source data from which the input edge data has been generated. The sentences may be the entire text of the document, may be a sentence ID=S001 of a sentence for which an edge is generated, or may be several sentences before and after the sentence. Other than this, node data may be referred to, source strings, and node strings related to subject section data node IDs, and object section data node IDs may be used, or sentences may be combined. A sentence from which only a word group to which attention is paid is taken out may be used. In addition, sentence vectors of different types may be coupled. For example, in one possible manner, a sentence vector of the abstract of writing, and a sentence vector of a node string are coupled to form one vector.

In order to vectorize sentences by using a technique of vectorizing words, word vectors of words obtained from target sentences are added together, and the sum is divided by the number of the words as illustrated in Formula (1) to derive the sentence vector of the target sentence. In Formula (1), Vtx is a sentence vector, wv(n) is the word vector of an n-th word, and k is the number of words obtained from a target sentence.

Vtx={wv(1)+wv(2)+ . . . +wv(k)}/k (1)

As illustrated in Formula (2), the sentence vector of the target sentence may be derived by: obtaining the weighted sum by multiplying the word vectors of words obtained from a target sentence by weighting factors, and adding together the word vectors; and dividing the weighted sum by the number of the words. In the formula, an is a weighting factor used for multiplication of an n-th word. Weighting factors may be determined according to any rule, and for example may be determined: (A) in accordance with parts of speech such that, for example, the weighting factors are increased for verbs and adjectival verbs; or (B) in accordance with positions of appearance in a target sentence such that, for example, the weighting factors are increased for words that appear at the start or end of the target sentence (or the opposite of this).

Vtx={α1·wv(1)+α2·wv(2)+ . . . +αk·wv(k)}/k (2)

Furthermore, for the output edge also, the sentence of the source data is similarly vectorized in accordance with the sentence vector model (S308). Subsequently, a similarity between the vector of the source data of the input edge, and the source data of the output edge is computed, and is stored in inter-edge background similarity data (S309). In the computation of the similarity, cosine similarity, Jaccard coefficient, and the like can be used. In this manner, the relevance analyzing device vectorizes documents corresponding to an edge to be input to a node included in an analysis target document, and an edge output from the node, and computes a similarity therebetween.

Similarities are computed (S310) for all the combinations of edges, and the process proceeds to the next node. The loop process is implemented for all the nodes, and is completed (S311). In this manner, the relevance analyzing device computes similarities for all the combinations of edges input to and output from each of all the nodes.

In FIG. 7, similarities are computed for combinations of input edges and output edges, and the computation results are stored in the similarity column (Similarity). Thereby, routes in the network including combinations of all edges can be obtained. By creating, in advance, the network irrespective of the levels of similarities in this manner, the speed of a route search performed by the relevance analyzing device can be increased.

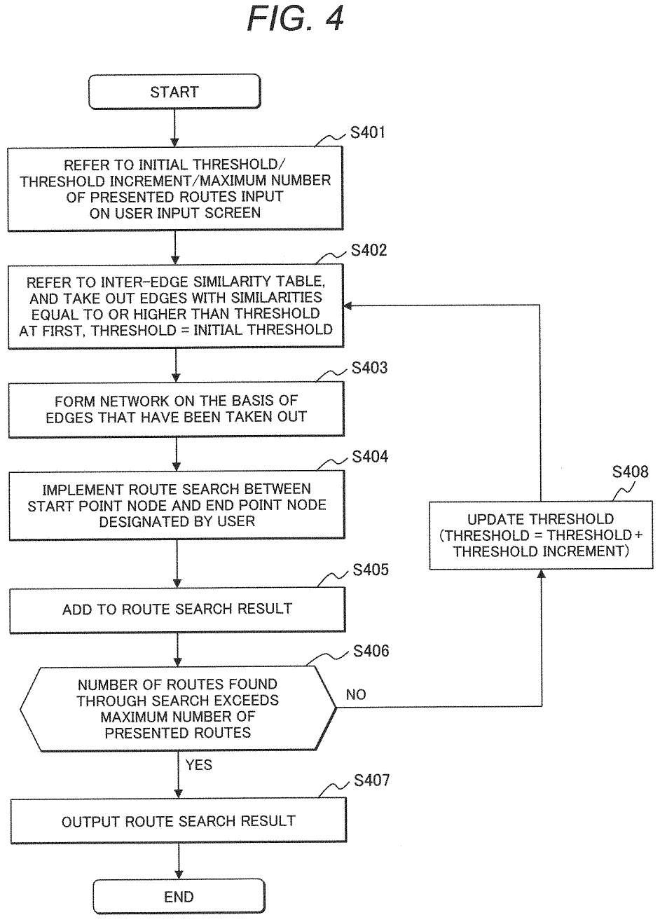

A flow of a process performed by the route computing section 202 of the relevance analyzing device in the present embodiment is illustrated by using FIG. 4. The initial threshold for inter-edge similarity, the increment of the threshold for inter-edge similarity, and the maximum number of presented routes input on a user input screen are referred to (S401). At the first time, the threshold is set to the initial threshold, the inter-edge background similarity table is referred to, and edges with similarities that are equal to or higher than the threshold are taken out (S402). A network is formed on the basis of the edges that have been taken out (S403). That is, the relevance analyzing device takes out edges with similarities computed as being equal to or higher than the predetermined threshold, and forms the network on the basis of the edges that have been taken out. Edge data IDs are used in the formation of the network.

In the list 701 illustrated in FIG. 7, data of each edge determined as having a high similarity in accordance with the threshold has the value “1” in the similarity threshold decision result column (Similarity Threshold). Other data has the value “0” in the similarity threshold decision result column. The relevance analyzing device 100 in the present embodiment generates a network by using input edge data IDs and output edge data IDs having Similarity_Threshold=1 which means that the similarities are determined as being high.

FIG. 9 illustrates one example of a generated network. In the network 901 in the figure, edges determine as having high similarities because the similarities are equal to or higher than the threshold are indicated by solid lines, and edges with low similarities are indicated by broken lines. In the figure, two routes (R001, R002) are displayed. The route computing section 202 receives a user input to the generated network, designates a start point node, and an end point node of a search, and implements a route search (S404). That is, the relevance analyzing device implements a route search between the start point node and the end point node that are designated by a user.

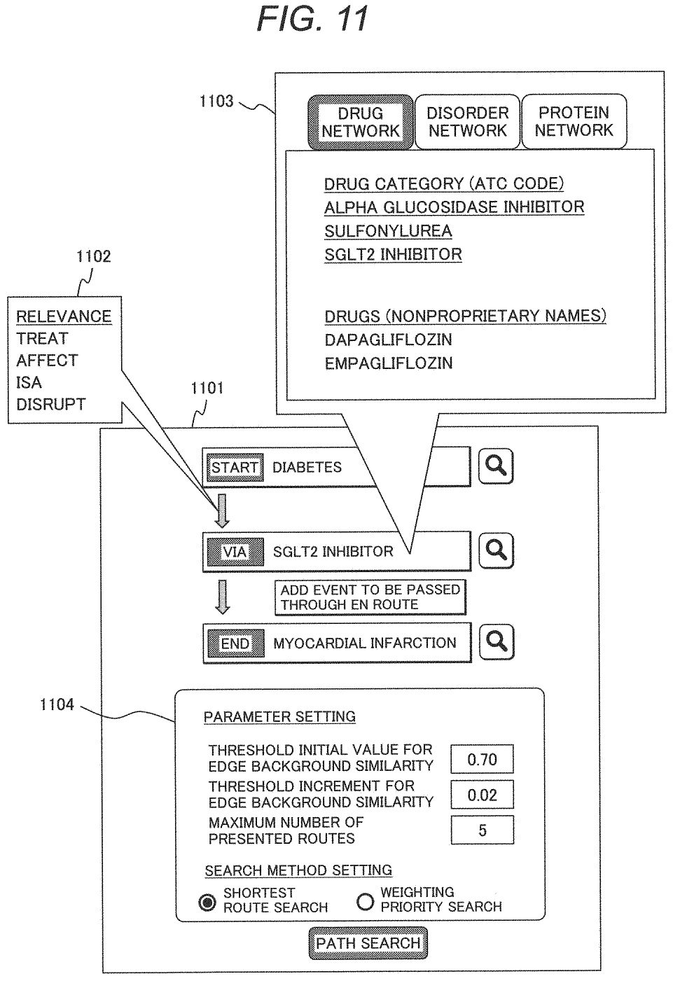

FIG. 11 illustrates one example of an input screen 1101 for a route search to be displayed on the display section 107 of the relevance analyzing device 100. In FIG. 11, a user designates diabetes as a start point, and designates myocardial infarction as an end point. Furthermore, a pop-up window 1103 may be opened on the input screen 1101 to designate events that should necessarily be passed through en route.

In the route search, a search problem such as a shortest route search, or maximization of weights that are given on the basis of the appearance frequencies of edges is solved. Obtained routes are stored in the memory route search results (S405). In a case where the number of the route search results is equal to or smaller than the maximum number of presented routes, the threshold for similarities is updated by the increment of the threshold (S407), and the route search is performed again (S406). In a case where the number of routes that could be obtained by the computation exceeds the maximum number of presented routes, the process end (S408).

Because the route computing section 202 of the present embodiment can perform a search by removing, in advance, unnecessary edges by keeping only edges with high inter-edge background similarities, it becomes possible to attempt to improve the speed of a route search process. In addition, because it becomes less likely that edges having different backgrounds are linked, routes whose meanings are easier to understand can be obtained. Furthermore, by adding together similarities of edges in an obtained route, an index of the background similarities of the route can be generated.

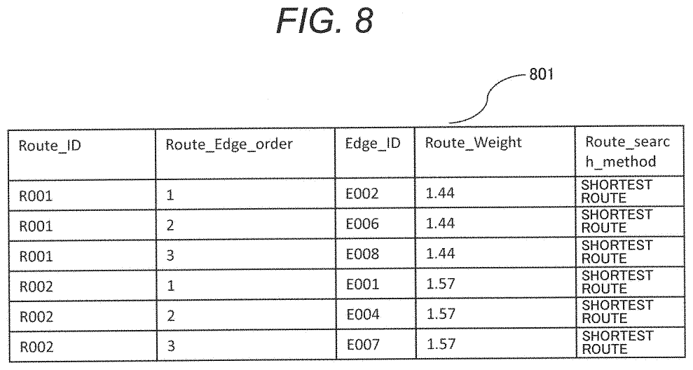

FIG. 8 illustrates a route search result example according to the present embodiment. As can be seen in route IDs (Route_ID) in the figure, it is illustrated that two routes (R001, R002) are obtained as a result. Note that edges included in the routes are illustrated as edge IDs (Edge_ID). As illustrated in the figure, the order of edge IDs in a route is stored as a route edge order (Route_Edge_Order). In addition, the inter-edge background similarity of a route is stored as a route weight (Route_Weight). In addition, a route search method (Route_search_method) such as a shortest route search is also record at the same time.

As has been explained above, the data structure of the node data 501 illustrated in FIG. 5 includes node IDs, node data IDs, source strings, node strings, node types, document IDs, and sentence IDs. Here, a node ID is an identifier uniquely given to each node. A node data ID is an identifier for identifying original data from which the node has been formed. A source string stores a representation character string in writing about original data from which the node has been formed. A node string stores a character string for which a matching portion has been taken out from a dictionary or the like on the basis of a source string. Dictionaries are keyword lists in which keywords are classified on the basis of concepts such as disorders, drugs, proteins, and the like, for example, and when a source string partially or entirely matches a dictionary word, the matching word is stored as a node string.

At that time, a node type is decided on the basis of classification in accordance with a disorder, a drug, a protein, or the like to which a keyword belongs. For example, in the node data 501 illustrated in FIG. 5, because the character string IL-18 is included in a protein dictionary, IL-18 is given the node type protein (Protein). A document ID is an identifier of an original literature from which a source string has been acquired. A sentence ID is an identifier given to a sentence in an original literature from which a source string has been acquired.

As mentioned before, the edge data 601 illustrated in FIG. 6 includes edge IDs, edge data IDs, affecting node IDs, affected node IDs, affecting entity node IDs, affected entity node IDs, relations, document IDs, and sentence IDs.

Here, an edge ID is an identifier uniquely given to each edge. An edge data ID is an identifier for identifying original data from which the edge has been formed. An affecting node ID represents an ID of a node serving as the start point of the edge. The affecting node ID is associated with a node ID in FIG. 5. An affected node ID represents an ID of a node serving the end point of the edge. Similarly, the affected node ID is associated with a node ID in FIG. 5. The affecting entity node ID and the affected entity node ID are identifiers for identifying original data from which affecting and affected nodes have been formed, respectively. A relation stores data representing a relation of a node. A document ID is an identifier of an original literature from which information of the edge has been acquired. A sentence ID is an identifier given to a sentence in an original literature from which information of the edge has been acquired.

One example of the data structure of inter-edge similarity data of the relevance analyzing device in the present embodiment is explained by using FIG. 7. The list 701 illustrated in FIG. 7 stores combinations of edges to be input to nodes, and edges to be output from the nodes as seen from the nodes, and background similarities between the input edges and the output edges. That is, input edge IDs, output edge IDs, input edge data IDs, output edge data IDs, similarities, and similarity threshold decision results are included.

Here, input edge IDs are identifiers of input edges related to similarity computation. Output edges ID are identifiers of output edges related to the similarity computation. Input edge data IDs are identifiers for identifying original data from which input edges related to the similarity computation have been acquired. Output edge data IDs are identifiers for identifying original data from which output edges related to the similarity computation have been acquired. Similarities are inter-edge background similarities. Similarity threshold decision results store results of determination of the levels of similarities based on a similarity threshold. In the example, “1” is input in a case where a similarity is high, and “0” is input in a case where a similarity is low.

One example of the data structure of route search result data is explained by using FIG. 8. Route search result data 801 illustrated in FIG. 8 stores: route IDs (Rout_ID), route edge orders (Rout_Edge_order), edge IDs (Edge_ID), route importance (Route_Weight), and route search methods (Route_search_method).

Here, a route ID is an identifier uniquely given to each route. FIG. 9 illustrates R001 and R002. Route edge orders indicate the order in which edges included in the route are coupled. An edge ID is an ID of an edge included in the route. Route importance indicates the importance of the route in a case where a plurality of routes are presented as a result. A route search method is data indicating what type of search method was used to generate the route in a case where a plurality of search methods are used as methods for searching routes in a network. Examples of the search methods include a shortest route search, a smallest weight route search, and the like. A shortest route search is used in FIG. 8.

Next, one example of the input screen used at the time of a route search in the present embodiment is explained by using FIG. 11. The input screen 1101 is displayed on the display section 107 illustrated in FIG. 1. An event to serve as the start point, and an event to serve as the end point are designated for a route, and a search for a route therebetween is implemented. On the input screen 1101, the start point/end point are input by a user. By adding events to be passed through en route, it is also possible to designate events to be necessarily passed through en route by using the pop-up window 1103. FIG. 11 illustrates a case where an SGLT inhibitor is added as an event to be passed through en route.

In addition, by using a pop-up window 1102, it is possible to designate a relation between events like the one illustrated in the figure also. That is, it is possible to input a relation between a plurality of events on the input screen 1101. In particular, a search by using wild cards is performed in a case where relations between events are not specified. It is also possible to perform a search by designating only types of events of a start point and an end point. In that case, only types such as proteins, disorders, or drugs are designated as types.

In addition, it is also possible to input on a sub-window 1104 an initial value of the threshold for inter-edge background similarity as a parameter. In addition, in a case where search results could not be obtained with the initial value, it is also possible to increase the threshold by an increment, and repeat a loop process until the number of search results reaches the maximum number of presented routes. It is also possible to designate a shortest route search or a smallest weight route search as a search method. By manipulating a path (route) search button on the input screen 1101, a search is started.

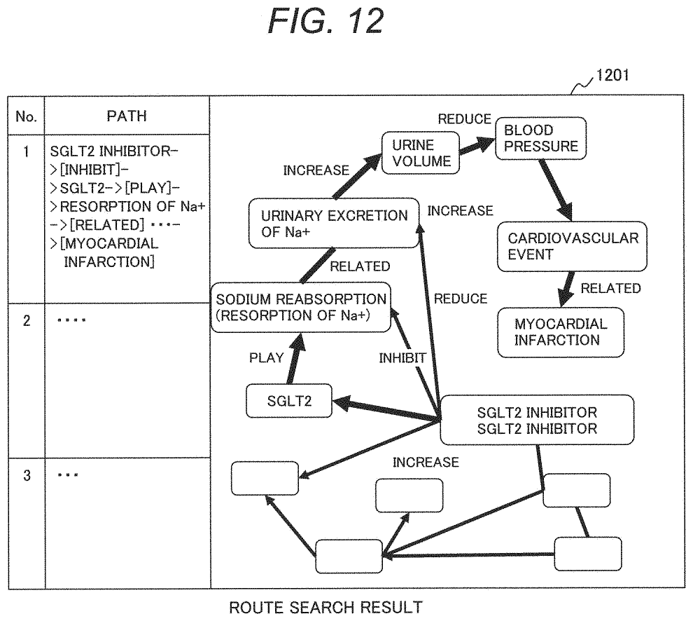

Next, one example of an output screen used to output a route search result of the relevance analyzing device in the present embodiment is explained by using FIG. 12. A route search result 1201 is displayed on the display section 107 illustrated in FIG. 1. A list of routes 1, 2, and 3 that are found as a result of a search is displayed as the route search result 1201, and it is made possible to check routes while having an overall look of a network by changing display colors of portions corresponding routes in the network or by other means. If there are a plurality of routes, it is also possible to superimpose the routes to be displayed, and it is also possible to display each route separately from the other routes.

In one possible configuration, links to original literatures from which edges or nodes have been formed can be provided on the route search result 1201 displayed on the display section 107. In addition, in a list illustrated on the left side of the route search result 1201, routes whose original literatures have higher background similarities may be displayed on the upper portions of the list. Thereby, a user can immediately obtain a route most suited for a purpose while comparing a plurality of routes.

### Second Embodiment

A second embodiment is an embodiment of: a relevance analyzing device that makes it possible to search for a related disorder, and examine an expansion of the application of a medicine in a case where there is a particular predetermined target gene; and a method therefor.

The same flow as the one in the first embodiment is used in the present embodiment up to the point until the network is created, but at user input for a route search, a node is designated as the start point, a type of node is designated as the end point, and a search for a route between two nodes is performed. In a case where a route is found, the string of a node at the end point is presented. For example, the second embodiment allows uses in which a search is performed by setting a target gene is set as a node of the start point, disorders are set as a type of the end point, and the string of a node of the end point found as a result of the search is presented as a candidate disorder to be included in the expanded application of the medicine.

In the present embodiment, at S403 in the processing flow illustrated in FIG. 4, a user designates not the string of an end point node but a type of the node. Specifically, a node type (Node_Type) in the node data 501 illustrated in FIG. 5 is designated. In a case where it is desired to search for a related symptom starting from a start point, for example, “Symptom” is designated as a node type. Thereafter, a route between the start point node and a node whose node type is “Symptom” is searched for (S405).

In a case where the number of routes found as a result of the search exceeds the maximum number of presented routes (YES at S406), the route search is ended, and the route search result is output (S407). Here, as the route search result, the strings of the end point nodes are presented along with routes. For example, in a case where end points are N005 and ND011 illustrated in the node data 501 illustrated in FIG. 5, “cardiac dysfunction” is presented along with routes.

According to the relevance analyzing device and method in the present embodiment, it is known that a symptom related to the start point is “cardiac dysfunction,” and this can be used as reference data that is useful when the application of a medicine is to be expanded.

### Third Embodiment

In the first and second embodiments explained, a high-speed route search is realized by pruning a network including pairs of two adjacent edges with high background similarities. In a relevance analyzing device and method in a third embodiment, constraints are not provided about edges, but a network including all the edges is created, and all the routes between two points designated by a user are listed. Then, background similarities between edges are computed for each route path, and paths on the network are presented in descending order of similarity.

Accordingly, in the present embodiment, a network is generated in advance on the basis of affecting node IDs, and affected node IDs in the data illustrated in FIG. 6. The thus-generated network corresponds to one in which all edges on the network illustrated in FIG. 9 are displayed without distinguishing them by using solid lines and broken lines, for example.

Note that although a topic model is used for determining background similarities in the method explained in the present embodiment, computations of the similarities are similarly possible even with the sentence vector generation method explained in the first embodiment.

In the topic model, when a document set is given, it is estimated what type of topic (topic) each document is written about. This is founded on the basis of a way of thinking that similar words appear in documents with the same topic, and on the basis of this supposed correlation, potential topics are estimated. One of the ways of creation of a topic model is LDA (Latent Dirichlet Allocation), or the like. In LDA, when a document group and the number of topics are given, words related to each topic, and the probabilities of appearance of the words are obtained. In addition, the probability of appearance of each topic is obtained about each document. The probability of appearance of each topic can be obtained also about a new document.

In the present embodiment, it is assumed that similar backgrounds mean similar topics, and similarities between topics of original literatures from which edges have been generated are computed. That is, treating a topic as a feature of each document, a cosine similarity between documents is computed as a similarity between topics of the literatures.

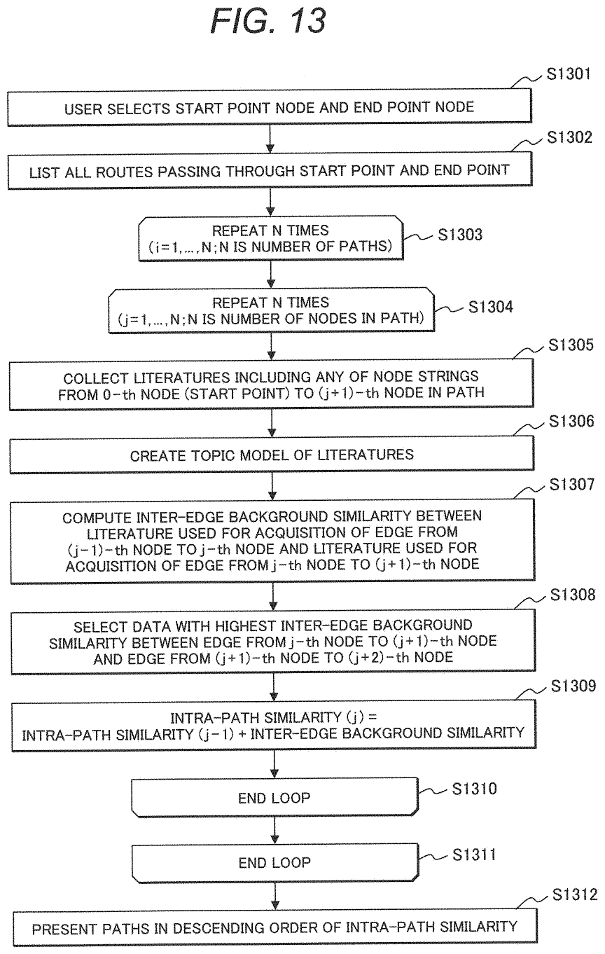

The flow of a process in the relevance analyzing device in the present embodiment of listing all the routes, and then computing background similarities about the routes is mentioned by using FIG. 13. On a user input screen, a user selects nodes to be a start point and an end point on a network (S1301).

It is supposed that the input screen 1101 like the one illustrated in FIG. 11 is used as the user input screen, for example. Then, all the routes whose start point node and end point node are nodes that are designated by a user input are searched for (S1302). Next, in order to compute the background similarities of all the routes, a loop process is performed for each route (S1303). In addition, at S1305 to S1308, background similarities in the route are computed sequentially starting from the start point node (S1304). First, literatures including source strings and node strings of a (j+1)-th node from the start point are collected (S1305). A topic model is created from the collected literature set (S1306).

Next, a literature used to acquire an edge from a (j−1)-th node to a j-th node in the route, and a literature used to acquire an edge from the j-th node to a (j+1)-th node are referred to, the probabilities of appearance of the literatures are computed, and using these probabilities of appearance of the topics as features of the documents, a cosine similarity between the documents is computed as a similarity between the topics of the literatures (S1307). In a case where an edge from the (j−1)-th node to the j-th node has a plurality of data IDs, an edge ID determined as having the highest similarity up to that point in the loop process is adopted as the data ID. In a case where an edge from the j-th node to the (j+1)-th node has a plurality of data IDs, a similarity is computed for each data ID. A combination of edges with the highest similarity is adopted (S1308). The similarities computed at S1307 and S1308 are added to the intra-path similarities. Similarities of all the nodes, and all the intra-route path similarities are computed (S1310, S1311). Finally, route paths are presented in descending order of intra-path similarities (S1312). In the relevance analyzing device in the present embodiment also, a route search can be implemented precisely and fast.

The present invention is not limited to the embodiments described above, but include various modifications. For example, the embodiments described above are explained in detail for better understanding of the present invention, and the present invention is not necessarily limited to embodiments including all the configurations explained.

Furthermore, although each configuration, function, computer or the like mentioned above is mainly explained about examples in which the program that realizes part of or the whole of it is created, each configuration, function, computer or the like mentioned above may be realized by hardware by designing part of or the whole of it, for example, with an integrated circuit or by other means, as mentioned before.

### REFERENCE SIGNS LIST

100: Relevance analyzing device
101: Data input/output section
102: Control section
103: Memory
104: Storage section
105: Binary relation database
106: Input section
107: Display section
201: Inter-edge background similarity computing section
202: Route computing section
206: Route
501: Node data
601: Edge data
701: List
801: Route search result data
901: Network
1101: Input screen
1102, 1103: Pop-up window
1104: Sub-window
1201: Route search result

What is claimed is:

1. A relevance analyzing device that analyzes relevance between a plurality of events, wherein a similarity between documents corresponding to an edge that is in a network representing relevance between a plurality of events and represents an interrelationship between two events is computed, and an edge with a high similarity is presented as a route on the network.

2. The relevance analyzing device according to claim 1, wherein documents corresponding an edge to be input to a node included in a document as an analysis target and an edge output from the node are vectorized to compute the similarity.

3. The relevance analyzing device according to claim 2, wherein similarities are computed for all combinations of edges that are input to and output from each node.

4. The relevance analyzing device according to claim 3, wherein edges with computed similarities that are equal to or higher than a predetermined threshold are taken out, and a route of the network is formed on the basis of the edges that have been taken out.

5. The relevance analyzing device according to claim 4, wherein a route search between nodes that are designated by a user as a start point and an end point is implemented.

6. The relevance analyzing device according to claim 4, wherein routes on the network are presented in descending order of similarities.

7. A relevance analyzing device comprising:
a control section; and
a database,
wherein the database stores: node data about nodes on a network representing relevance between a plurality of events; and edge data about edges representing interrelationships between the plurality of events, and
the control section includes an inter-edge background similarity computing section that computes a similarity between documents corresponding to two edges by using the stored node data and edge data.

8. The relevance analyzing device according to claim 7, comprising a route computing section that computes a route with a high similarity as a route on the network.

9. The relevance analyzing device according to claim 8, wherein the route computing section takes out edges with similarities that are equal to or higher than a threshold, and forms a route on the network on the basis of the edges that have been taken out.

10. The relevance analyzing device according to claim 9, wherein the route computing section implements a route search between nodes that are designated by a user as a start point and an end point.

11. The relevance analyzing device according to claim 10, comprising an input/output section through which the start point node and the end point node can be input.

12. The relevance analyzing device according to claim 11, wherein relations between the plurality of events can be input through the input/output section.

13. A relevance analysis method of analyzing relevance between a plurality of events by a control section, wherein the control section computes a similarity between documents corresponding to an edge that is in a network representing relevance between a plurality of events and represents an interrelationship between two events, and presents, as a route on the network, an edge with a high similarity.

14. The relevance analysis method according to claim 13, wherein the control section vectorizes documents corresponding an edge to be input to a node included in a document as an analysis target, and an edge output from the node to compute the similarity.

15. The relevance analysis method according to claim 14, wherein the control section implements a route search between nodes that are designated by a user as a start point and an end point, and presents routes in descending order of similarities as routes on the network.
